(19) United States
(12) Patent Application Publication
(10) Pub. No.: US 2025/0384796 A1
(43) Pub. Date: Dec. 18, 2025

(54) RETRACTABLE BANNER ASSEMBLY

(71) Applicant: Andrew Eric Reiner, Park City, UT (US)

(72) Inventor: Andrew Eric Reiner, Park City, UT (US)

(21) Appl. No.: 18/746,874

(22) Filed: Jun. 18, 2024

(51) Int. Cl. G09F 11/08; G09F 11/00

(52) U.S. Cl. CPC G09F 11/08; G09F 2011/009

(57) ABSTRACT

A retractable banner assembly having a housing assembly and a mounting rod coupled directly or indirectly thereto, wherein the housing assembly articulates relative to a support structure responsive to an applied pull force on a rollable banner coupled directly or indirectly to the mounting rod, thereby promoting the banner to remain substantially flat on extension and retraction and when in a deployed state.

### CROSS-REFERENCE TO RELATED APPLICATIONS

None

### TECHNICAL FIELD

This invention relates generally to an improved retractable banner assembly for use in commercial, public and residential spaces, indoors and outdoors, to route persons and/or inhibit access to designated areas, and to effectively impart communications in an aesthetically pleasing manner, and more specifically to such an assembly wherein a housing assembly having a mounting rod coupled directly or indirectly thereto articulates about an axis relative to a support structure, responsive to a direction of an applied pull force on a rollable banner coupled directly or indirectly to the mounting rod, promoting the banner to remain substantially flat on extension, when in a deployed state, and on retraction.

### BACKGROUND OF THE INVENTION

Residential safety gates, particularly child and pet safety gates, are well known in the art for use in inhibiting or preventing access to living areas such as kitchens, stairways, basements, garages, and the like, that may be unsafe or undesirable for children or pets. They typically comprise a plurality of cooperating and substantially rigid gate sections, comprised of wood, plastic, metal, and the like, and are generally horizontally extensible and retractable specifically within corresponding narrow entryways such as between doorjambs, opposed walls, balustrade uprights, and the like. They are also commonly provided on the ends thereof with compressible buffer stops comprising elastomeric material or other suitable spring mechanisms, which when compressed and then released, function to effectively set the corresponding gate or gate sections against displacement between the respective opposed fixed extremes defined by the narrow entryways. Additional safety latches have been used to further secure the relative positions of the corresponding gate sections and prevent inadvertent or undesired disengagement of the same following installation. To remove the gates after installation, the safety latches, if any, must first be disabled or released whereupon the buffer stops may be compressed, generally by applying lateral pressure to the same, to temporarily relieve applied tension on the opposed fixed extremes of the corresponding entryways. The rigid gate sections may then be sufficiently retracted and typically slid back for the gate or gate system to be removed.

Variations of the above safety gates have included a rollable fabric section, interchangeably referred to as a banner, that is affixed to a rotatable spool, typically under tension, and disposed within and rotatably coupled to a housing. The housing, in turn, is affixable to a support structure such as the above referenced doorjambs, opposed walls, balustrade uprights, and the like. The fabric section is typically extensible from the spool in the x direction, in an x-y-z reference system, for deployment through an elongate opening in the housing, responsive to an applied force. The fabric section is subsequently maintained in a deployed state wherein the fabric is partially or fully extended from the spool and typically coupled at a leading edge thereof to an opposing door jamb, balustrade upright, or the like, when the applied force is substantially constant. It is retractable to the spool through the same opening responsive to a reduction in the applied force. As the fabric is extended, the spool rotates in a first direction about an axis of rotation oriented in the z direction, according to the x-y-z reference system, and as the fabric is retracted, the spool rotates about the z axis in a second and opposing direction.

Rollable fabrics may exhibit physical fabric distortions upon extension and retraction from a spool, and when in a deployed state, including bunching, twisting, sagging, and the like, which create unevenness in the fabric section. As those skilled in the art will recognize, these structural distortions may arise due to the fabric's inherent physical structure or characteristics. Mechanical distortions are also known to arise when the force applied to extend the banner, the force applied to hold the banner in the deployed state, or the reduced applied force to retract the banner (individually and collectively referred to herein as the “applied pull force” or “applied pulling force”) is not distributed equally across a referenced cross section of the fabric, typically, but not necessarily, a cross-section in the y-z plane according to the above-reference x-y-z reference system. As those skilled in the art will further recognize, this typically occurs when the direction of the applied pull force is other than substantially perpendicular or “normal” to the axis of rotation of the spool (referred to herein in some places as an “off-center” applied pull force individually and “off-center” applied pull forces collectively). Using the x-y-z axes as references, if the axis of rotation of the spool is represented by the z-axis, the greater the deviation from normal of the applied pull force relative to the z-axis, the greater the distortion will be. It being understood that the housing, with included spool coupled thereto and fabric section similarly coupled to the spool, may be positioned in any orientation and the x-y-z axes reference system, which is for reference purposes only, will align so that the axis of rotation of the spool relative to the housing is always represented by the z-axis and the direction of pull and retraction of the fabric when normal to the z axis is always in the x direction. Accordingly, the housing may be oriented in any manner, including vertically, horizontally, or anywhere therebetween in reference to a walking surface, but still for rotation about a z axis, applied pull force in the x direction, and regardless of such orientation, the greater the deviation from normal of the applied pull force, the more pronounced the distortions will typically be. Where the above referenced structural distortions exist, they will be exacerbated by the foregoing mechanical distortions. Where none exist, such mechanical distortions will still arise. These mechanical distortions and resulting unevenness, which prevent the fabric section from remaining flat, not only prevent the fabric section from being smoothly extended and retracted but impair its ability to effectively impart communications such as by way of example and not limitation, printing on one or both sides thereof when in a deployed state due to resulting obstructions to visibility. Even if printed communications are not obstructed, the foregoing distortions make communications significantly less pleasing. Accordingly, the above referenced safety gates have thus been found to be both functionally limited, if not inoperative, and aesthetically unappealing.

Safety gates have similarly been used in retail, warehouse, and other commercial environments to temporarily prevent access to selected areas, sometimes to block or inhibit access through corresponding entryways such as shopping aisles, and the like, as may be defined, for example, by shelving and storage racks such as pallet rack systems and assemblies. Like the above-referenced child safety and pet gates, these gates, have included variations wherein a rollable fabric section is affixed to a rotatable spool, again typically under tension, which is disposed within and rotatably coupled to a housing. The housing, in turn, is affixable to a support structure at the entryway such as the above referenced checkout aisle, pallet rack assembly, and the like. The support structure may also be a base, a stanchion, or similar structure. The fabric section is similarly extensible from the spool in the x direction, in the x-y-z reference system, for deployment through an elongate opening in the housing, responsive to an applied pull force. It is maintained in a deployed state wherein the fabric is partially or fully extended from the spool. It is similarly retractable to the spool through the same opening responsive to a reduction in the applied pull force. In one variation, the referenced housing may rotate about an axis of rotation that is parallel to or coaxial with an axis of rotation of the spool. The housing and spool are otherwise restrained thereby limiting both to this rotational movement about the z axis only and prohibiting all further movement relative to the support structure. As those skilled in the art will recognize, this permitted movement of the housing about the z axis is typically referred to as yaw. For background purposes, roll, pitch, and yaw are the three dimensions of movement or rotation of an object in three-dimensional space. The three dimensions are defined as follows: (1) roll: rotation around the front-to back axis (x axis); (2) pitch: rotation around the side-to-side axis (y axis), interchangeably referred to as articulation herein; and (3) yaw: rotation around the vertical axis (z axis). Again, the fabric sections used in these retractable banner variations may exhibit structural fabric distortions upon extension and retraction from the spool, and when in a deployed state, including bunching, twisting, sagging, and the like, resulting from their physical structure or characteristics which create unevenness therein. Mechanical distortions will also arise and will exacerbate existing structural fabric distortions where present when the applied pull force is not distributed substantially equally across a cross section of the fabric which again typically results when the direction of the applied pull force is not substantially perpendicular to the axis of rotation of the spool and is accordingly off-center. That is, it is not substantially perpendicular to the z reference axis. These mechanical distortions and resulting unevenness similarly prevent the fabric section from being flat, and thereby prevent the fabric section from being smoothly extended and retracted and impair its ability to effectively and pleasingly impart communications on one or both sides thereof when in a deployed state and may result in obstructions to user visibility. Accordingly, these rollable safety gates have therefore been found to be both functionally limited, if not inoperative, and aesthetically unappealing.

Various gates and barriers have similarly been proposed for use in preventing access to specified outdoor work, pedestrian, and recreation areas such as pools and the like and to define enclosures. As in the case of the above-referenced safety gates, even where rollable banner sections have been utilized, the sections remain prone to structural fabric distortions upon extension and retraction of the corresponding gate sections, and when in a deployed state, and mechanical distortions when the direction of the applied pull force on the gate is not substantially perpendicular to the axis of rotation of the spool, again the z reference axis. Again, Where the above referenced structural distortions exist, they will be exacerbated by the foregoing mechanical distortions. Where none exist, such mechanical distortions will still arise These mechanical distortions and resulting unevenness, which prevent the gate from being flat, similarly prevent the gate from being smoothly extended and retracted and impair the ability of the gate to effectively impart communications on one or both sides thereof when in a deployed state due to resulting obstructions to user visibility. Such gates are similarly typically not designed or intended to be interconnected to define corresponding pathways, to guide, or route persons or vehicles there through, to inhibit undesired ingress to or egress from such defined pathways or across extended lengths, or to effectively impart communications on one or both sides thereof.

Stanchion top retractable belts have been used in public and private waiting areas and queues such as transportation centers (airports, train stations, bus stations, etc.), museums, event centers (theatres, concert halls, etc.), ticket offices, and the like, for specific traffic control purposes. A typical such stanchion top retractable belt generally comprises a small top cap affixed or affixable to an upright stanchion supported by a weighted or fixed base. A narrow belt or tape, typically comprising a thick and generally heavy webbing material, is affixable to a rotatable spool, typically under tension, which is disposed within and rotatably coupled to the top cap. The tape is extensible from the spool in the x direction, according to the x-y-z reference system, for deployment through an opening in the top cap, responsive to an applied pull force on the fabric section which may be variable, maintained in a deployed state wherein the fabric is partially or fully extended from the spool and typically coupled at a leading edge thereof to a suitable support member when the applied pull force is substantially constant, and retractable to the spool through the same opening responsive to a reduction in the applied pull force. While such stanchion top retractable belts may be suitable for the limited purposes to which they address, they are not suitable for the purpose of the present invention as heretofore described. Namely, as indicated above, these top mounted extensible belts are directed principally to guiding and routing persons along predetermined designated pathways. They structurally cannot and do not prohibit ingress or egress therefrom, as persons can readily duck under the corresponding tapes (and depending on the height of the combined stanchion and top cap, possibly step over the belt). As in the case of the above-referenced safety gates, stanchion top belts may also exhibit structural fabric distortions upon extension and retraction of the corresponding tapes, and when in a deployed state, including bunching, twisting, sagging, and the like. These distortions may result from the physical structure or characteristics of the fabric, namely the thickness and weight of the webbing material typically used. Mechanical distortions are also known to arise and will again exacerbate the foregoing structural distortions where present when the direction of the applied pull force on the tape is not substantially perpendicular to the axis of rotation of the spool, again the z reference axis. These mechanical distortions, caused by the foregoing off-center applied pull forces, and resulting unevenness, again prevent the tape from lying flat thereby preventing the tape from being smoothly extended and retracted and further impairing the ability of the tape to effectively impart communications when in a deployed state due to resulting obstructions to user visibility.

U.S. Pat. No. 9,714,491 to Wettern discloses a rollable fabric gate variation wherein a spool or “bobbin” as it is referred to therein, is disposed within and rotatably coupled to a housing supported by a base member for placement on a walking surface. The bobbin is pinned at one end thereof, referred to for convenience as a proximal end, thereby allowing it to move about the y reference axis at its opposing or distal end only, and within a narrow range of pitch limited by the internal space of the housing. Similar to the above referenced gates, however, the housing is fixed with no range of roll, pitch, or yaw, and accordingly, has no movement about any axis relative to the base, a support structure, or a walking surface on which the base may be placed on or proximate thereto. Wettern thus provides only a partial and limited solution for reducing banner surface unevenness resulting from certain off-center pulling forces.

Notably, in all of the foregoing retractable fabric gates, with the exception of the one variation wherein the housing may rotate about the z reference axis, the housing is otherwise fixed with no range of yaw or roll and more importantly, no range of pitch, interchangeably referred to herein as articulation generally, and rotation about the y reference axis specifically. Still further, while the spool rotates about the z reference axis within the housing, with the exception of the Wettern variation, the spool similarly has no range of rotation about the x or y reference axes.

Accordingly, there is a need for an improved retractable banner assembly to promote the smooth extension and retraction of the banner, wherein the banner has reduced mechanical distortions therein and when in a deployed state, in each case responsive to an applied pull force, to effectively impart aesthetically pleasing communications to users.

Still further, there is a need for such a retractable banner assembly which enables the applied pull force to be equalized at least in part across at least a cross section of the banner, particularly when such applied pull force is in a direction other than substantially normal to an axis of rotation of the spool, again the z-reference axis, including when the force and/or direction thereof are variable, to promote the banner to remain substantially flat on extension and retraction, and when in a deployed state, as applicable.

Yet still further, there is a need for such an improved retractable banner assembly that may be implemented alone or in combination with other such assemblies to define one or more pathways in residential, commercial, and/or public spaces, indoors and outdoors, to route persons through such pathways, and/or to block or otherwise inhibit access to designated areas.

### SUMMARY OF THE INVENTION

It is a principal object of the present invention to provide an improved retractable banner assembly having a housing assembly having a mounting rod coupled directly or indirectly thereto, wherein the housing assembly articulates relative to a support structure, responsive to a direction of an applied pull force on a rollable banner coupled directly or indirectly to the mounting rod, promoting the banner to remain substantially flat on extension, when in a deployed state, and on retraction.

It is a further object of the present invention to provide such a retractable banner assembly wherein articulation of the housing assembly enables equalization at least in part of the applied pull force across at least a cross section of a banner, promoting the banner to remain substantially flat on extension, when in a deployed state, and on retraction.

It is a further object of the present invention to provide such a retractable banner assembly wherein articulation of the housing assembly enables equalization at least in part of the applied pull force across at least a cross section of the banner, which may be in the y-z plane.

It is a further object of the present invention to provide such a retractable banner assembly wherein the assembly is for selective placement by a user on or proximate to a walking surface, and the housing assembly may articulate about an axis oriented substantially parallel to the walking surface.

It is a further object of the present invention to provide such a retractable banner assembly wherein the housing assembly may articulate about a plurality of axes, in each case responsive to a direction of an applied pull force, providing the housing assembly with ranges of pitch.

It is a further object of the present invention to provide such a retractable banner assembly wherein the housing assembly may further rotate about a plurality of axes, in each case responsive to a direction of an applied pull force, providing the housing assembly with corresponding ranges of roll and/or yaw.

It is a further object of the present invention to provide such a retractable banner assembly that may be readily interconnected with one or more like assemblies, or other fixed or portable end points, to define corresponding pathways, to guide or route persons or vehicles through such pathways, and/or to inhibit access to designated areas.

In carrying out these and other objects, features, and advantages of the present invention, there is provided a retractable banner assembly having an elongate mounting rod that is rotatably coupled directly or indirectly with a housing assembly and is further coupled directly or indirectly to a rollable banner. The banner is extensible from the mounting rod for deployment and retractable to the mounting rod, in each case responsive to an applied pull force as defined herein. The housing assembly may be coupled directly or indirectly with a support structure to enable articulation of the housing assembly relative to the support structure, and in the direction of the applied pull force. This articulation of housing assembly enables equalization at least in part of the applied pull force across at least a cross section of the banner, preferably, but not necessarily in the y-z plane, which depending on the orientation of the banner relative to a walking surface, may be referred to as a vertical cross-section as referred to herein, promoting the banner to remain substantially flat on extension and retraction, and when in a deployed state.

These and other objects, features, and advantages of the present invention will be more readily apparent by reference to the following brief description of the drawings and best modes for carrying out the invention. It is to be understood that the drawings and description are solely for exemplary purposes and are not intended to limit, and do not limit, the scope of the invention as set forth in the accompanying claims.

### BRIEF DESCRIPTION OF DRAWINGS

FIG. 1 is a perspective diagram of one preferred, but not required, embodiment of the improved retractable banner assembly of the present invention;

FIG. 2 is a top plan view of the improved retractable banner assembly of FIG. 1 showing a range of rotation provided the spool and housing assembly about the z or yaw axis;

FIG. 3 is a side elevational diagram of the improved retractable banner assembly of FIG. 1 showing a range of articulation provided the spool and housing assembly about the y or pitch axis;

FIG. 4 is a perspective diagram of an alternative embodiment of the improved retractable banner assembly of the present invention;

FIG. 5 is a perspective view of a further alternative embodiment of the improved retractable banner assembly of the present invention;

FIG. 6 is a perspective view of yet a further alternative embodiment of the improved retractable banner assembly of the present invention;

FIG. 7 is a perspective view of a still further alternative embodiment of the improved retractable banner assembly of the present invention;

FIG. 8 is a perspective view of a further alternative embodiment of the improved retractable banner assembly of the present invention;

FIG. 9 is a side elevational view of the improved retractable banner assembly of FIG. 8 showing a range of articulation provided the spool and housing assembly about the y or pitch axis;

FIG. 10 is a top plan view of the improved retractable banner assembly of FIG. 8 showing a range of rotation provided the spool and housing assembly about the z or yaw axis;

FIG. 11 is a side elevational view of a further alternative embodiment of the improved retractable banner assembly of the present invention and showing a range of articulation provided the spool and housing assembly about the y or pitch axis;

FIG. 12 is a perspective view of the improved retractable banner assembly of FIG. 11 showing ranges of rotation provided the spool and housing assembly about a plurality of x or roll axes, y or pitch axes, and z or yaw axes;

FIGS. 13A-13B are side elevational views of the improved retractable banner assembly of FIG. 1 as implemented with an off-center forces F applied thereto upon extension illustrating the articulation feature of the present invention about common y or pitch axis.

It is understood that the above referenced drawings are incorporated herein as part of the disclosure of the claimed invention which will be described in further detail below.

### DETAILED DESCRIPTION OF THE INVENTION

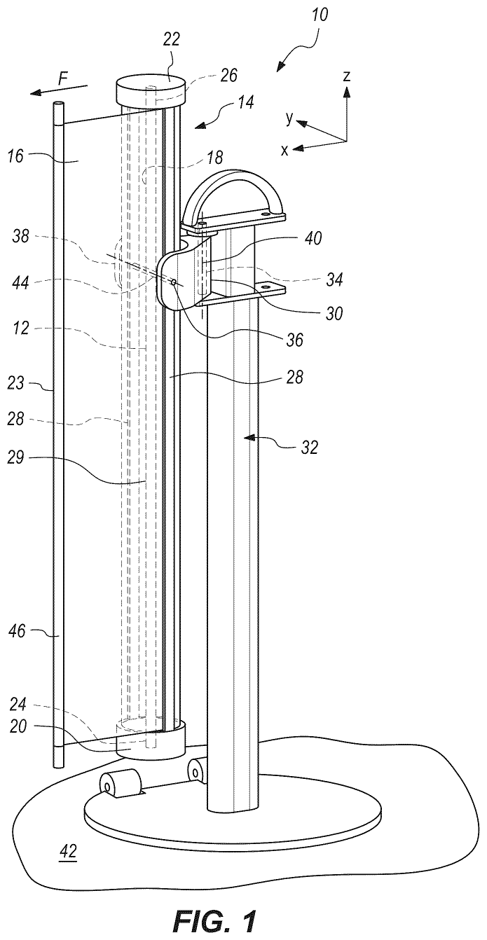

With reference to FIG. 1 of the drawings, there is provided a perspective diagram of one preferred, but not required, embodiment of the improved retractable banner assembly of the present invention designated generally by reference numeral 10. As shown, retractable banner assembly 10 comprises a housing assembly 14 that may be coupled directly or indirectly with a support structure 32. Banner assembly 10 includes an elongate mounting rod 12, interchangeably referred to as a spool, that is rotatably coupled directly or indirectly with housing assembly 14. A rollable fabric 16, interchangeably referred to as a banner or flexible banner, is further affixable directly or indirectly at a trailing edge 18 thereof to spool 12 for winding thereon. As shown, housing assembly 14, and specifically its respective proximal and distal retaining members or caps 20 and 22, retain corresponding proximal and distal spool ends 24 and 26 allowing spool 12 to rotate within housing assembly 14 while restricting, and in a preferred embodiment prohibiting, all further movement thereof. Retaining members 20 and 22 accordingly allow spool 12 to rotate in a first direction about its center axis, interchangeably referred to as the z reference axis or yaw axis, responsive to an applied pull force F on a leading edge 23 of rollable banner 16, which may be variable and off-center, to rotate in a second and reverse direction about the same z or yaw axis upon release or reduction in whole or part of the applied pull force F, and to remain substantially in place when banner 16 is in a deployed state with a substantially constant holding force F applied thereto. As indicated above, force F is referred to herein for ease of reference as an applied pull force.

In keeping with the invention, housing assembly 14 thus minimally comprises retaining members 20 and 22, or a single retaining member that performs the same function thereof such as by way of example, and not limitation, a component that encircles and captures spool 12, and at least one frame side 28 extending therebetween for further direct or indirect coupling to a support structure 32 as described in further detail below. In the embodiment shown in FIG. 1, housing assembly 14 includes 2 frame sides 28 which couple with a suitable pivot assembly or pivot member 30 and enable articulation of housing assembly 14 providing a range of pitch of housing assembly 14 relative to support structure 32. It is to be understood that any suitable coupling of housing assembly 14 with support structure 32 which enables housing assembly 14 to articulate relative to support structure 32 will achieve the objectives of the present invention. As discussed in further detail below, such a coupling may accordingly be provided by any suitable coupling assembly comprising one or more components or coupling member (interchangeably referred to as a pivot assembly or pivot member) which, in either case, may comprise one or more components and may also be integral in whole or in part with either the housing assembly 14, the support structure 32, or both. Significantly, housing assembly 14 may, but is not required to, enclose spool 12 in whole or in a relevant part, again depending on the application. As shown in FIG. 1, for example, housing assembly 14 may accordingly comprise interconnected frame sides 28 which only enclose spool 12 to a very limited extent and have an elongate opening through which banner 16 may be extended for deployment, maintained in a deployed state, and retracted. It is thus contemplated as part of this invention that while the housing assembly 14 may accordingly fully enclose spool 12, it may also be diminished to only enclose a small portion thereof as shown and could take more of a form of a frame as minimally needed to allow the spool 12 to couple and rotate within it, and for connection to an external structure. Regardless of the extent of coverage of the housing, and which, if any components, that it partially or fully encloses, it will be referred to herein as a housing. For further clarity, it is understood that housing assembly 14 may take any suitable form, have any suitable thickness, shape, and structure, including having one or more openings therein, and be comprised of any suitable material or materials manufactured in any suitable process or processes, including by way of example, and not limitation, any metal, polymer, paper based, ceramic, clay, plastic, wood, or the like, or any combination thereof included any suitable composite material comprising any of the foregoing or additional material or materials.

Still referring to FIG. 1, retractable banner assembly 10 may also include a winding mechanism such has a hand crank or the like (not shown) and/or any suitable biasing or winding means including a spring, or similar mechanical or electromechanical mechanism (not shown) operative to apply a force on spool 12 and thus banner 16. In such case, a threshold pull force will be required to unroll and thus extend banner 16 from spool 12 for use and deployment. Such biasing means may further cause banner 16 to roll and thus retract upon release in whole or part of the threshold or applied pull force F, and preferably, but not necessarily, return to a fully rolled storage position.

In keeping with the invention, spool 12 may have any suitable length, shape, thickness, and corresponding profile depending on the desired application and functionality and may comprise any suitable material and structure manufactured through any suitable process. By way of example only and not limitation, spool 12 may therefore comprise as shown, a narrow, elongated, extruded aluminum tube that is at least partially hollow, having a relatively uniform internal cylindrical cross-section, and defined by opposing top and bottom flat ends. Alternatively, spool 12 may comprise in any suitable combination, a thicker, shorter, tube, rod or dowel having a curved or otherwise irregular shaped core with a non-uniform internal cross-section in whole or in part that may be solid and defined by rounded, curved, or slanted ends or any variation thereof. Accordingly, it is understood that the exterior and visible surface 29 of spool 12 and its respective proximal and distal ends 24 and 26 may be styled to user preferences in each case independently of the internal cross section of spool 12 without departing from the scope of the invention herein.

Spool 12 may be comprised of any suitable original or recycled material again including by way of example and not limitation, any metal, polymer, paper based, ceramic, clay, plastic, wood, or the like, or any combination thereof included any suitable composite material comprising any of the foregoing or additional material or materials. In keeping with the invention, the exterior surface 29 of spool 12 may be smooth as shown or textured in whole or in part, including any etching or deposition of material including coating and/or laminating with any suitable material as desired for protection, ornamentation, and/or to enhance its performance. As indicated above, trailing edge 18 of rollable banner 16 may be coupled directly or indirectly to spool 12, internally, externally, and removably, as desired, in any suitable manner including through one or more adhesives, fasteners, or intermediate linking structures or components, depending on the application and desired functionality. The coupling may be permanent or temporary. By way of example only, and not limitation, an additional dowel, not shown, may therefore be provided in mechanical communication with trailing edge 18 for placement within or about one or more internal or external channels or raised edges, also not shown, of spool 12 that may be formed thereon at any suitable point thereof through extrusion, coating, cutting, or the like.

Still referring to FIG. 1, and in keeping with the invention herein, pivot member 30, interchangeably referred to as a mounting bracket, directly or indirectly couples housing assembly 14 to any suitable support structure 32 such as by way of example only and not limitation, a stanchion as shown, a support member of a pallet rack assembly, a retail check-out aisle, a wall, post or any other structure and the like. Support structure 32 may accordingly be fixed, mountable, portable, self-supporting, anchored, anchorless, stanchion based, or incorporate any other suitable form and structure. In one exemplary, but not required embodiment shown in FIG. 1, pivot member 30 is coupled directly or indirectly to a pin 34 of support structure 32 (shown in FIG. 1 as a stanchion) and is further coupled directly or indirectly to housing assembly 14 at pivot points 36 and 38, respectively. It is noted that points 36 and 38 may also, in an alternative embodiment, be points at which an axle is fixed which may then extend through any suitable component or assembly of components further affixable to housing assembly 14, wherein the pivot action may accordingly take place within the latter component or components. In the example illustrated, the coupling at pin 34 enables pivot member 30 and thus housing assembly 14 to rotate about pin 34 and yaw axis 40 relative to the support structure 32 and a walking surface 42 responsive to a direction of the applied pull force F, which force and/or direction may be variable. More specifically, the coupling enables housing assembly 14, spool 12, and rollable banner 16, to all rotate together (i.e., substantially concurrently) about pin 34 and common yaw axis 40 defined thereby relative to the support structure 32 and a walking surface 42, again responsive to a direction of the applied pull force F. In the embodiment shown, this common axis 40 is oriented substantially vertically as a z axis and is accordingly substantially parallel to support structure 32 and substantially perpendicular to walking surface 42, it being understood that any suitable orientation of axis 40 may be acceptable depending on the desired application of the retractable banner assembly 10 and the corresponding structure of pivot member 30. For example, pin 34 may be oriented such that its axis of rotation 40 is oriented in any direction. As those skilled in the art will recognize, axis 40 accordingly aligns with the reference z axis and stays there, while assembly 10 and the x-y-z reference system moves to any orientation of space. In keeping with the invention, the coupling of pivot member 30 at pivot points 36 and 38 of housing assembly 14 further enables pivot member 30 and again housing assembly 14 to articulate up and down about pitch axis 44 relative to the support structure 32 and walking surface 42, again responsive to a direction of the applied pull force F. More specifically, the coupling enables, pivot member 30, housing assembly 14, spool 12, and rollable banner 16, to all move together and thus articulate up and down substantially concurrently about common pitch axis 44. In the embodiment shown, this common axis 44 is oriented substantially horizontally as a y axis and thus substantially perpendicular to support structure 32 and substantially parallel to walking surface 42, again it being understood that any suitable orientation of axis 44 may be acceptable depending on the desired application of the retractable banner assembly 10 and thus the structure of pivot member 30. In keeping with the invention, the aforementioned articulation of housing assembly 14 about pitch axis 44 relative to the pivot member 30, support structure 32, and walking surface 42, responsive to a direction of the applied pull force F, enables equalization of at least part of force F across at least a cross-section 46 of rollable banner 16 thereby promoting rollable banner 16 to remain substantially flat on extension and retraction as well as when in a deployed state.

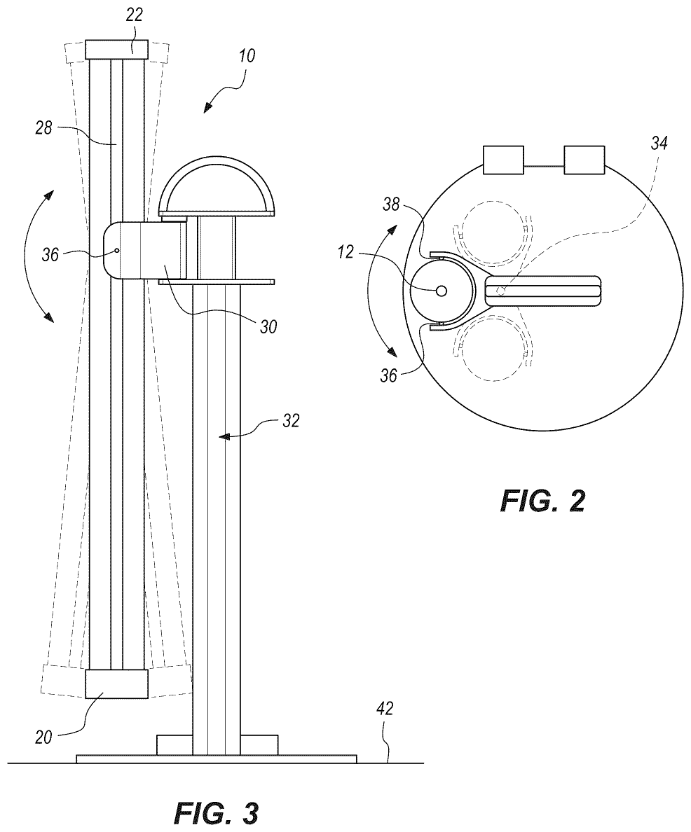

FIGS. 2-3 provide further detail of the rotation and articulation features of the present invention, which provide corresponding ranges of yaw, and pitch, for housing assembly 14 and spool 12, described above according to one preferred, but not required, embodiment wherein common axis 40 is oriented substantially vertically as a z axis and is accordingly substantially parallel to support structure 32 and substantially perpendicular to walking surface 42, and common axis 44 is oriented substantially vertically as a y axis and is accordingly substantially perpendicular to support structure 32 and substantially parallel to walking surface 42. Again, it is understood that any suitable orientation of axes 40 and 44 may be acceptable depending on the desired application of the retractable banner assembly 10 and the corresponding structure of pivot member 30. Referring to FIG. 2, for example, arrow 31 illustrates rotation of housing assembly 14 (along with spool 12 and banner 16) about z reference axis or yaw axis 40 relative to support structure 42 about pin 34 and yaw axis 40 defined thereby relative to the support structure 32 (and shown more specifically in FIG. 1) and a walking surface 42 responsive to a direction of the applied pull force F, which force and/or direction may be variable. Arrow 33 of FIG. 3 similarly illustrates articulation of housing assembly 14 (along with spool 12 and banner 16) about pin 36 and pitch axis 44, again responsive to a direction of the applied pull force F, which force and/or direction may similarly be variable. It should be noted that FIGS. 1, 2 and 3 show the pitch axes in the connection of the pivot member 30 to the housing assembly 14, however, in other embodiments contemplated by the present invention, the pitch axes may be in the connection between the pivot member 30 and the support structure 32. In still different embodiments contemplated by the present invention, the pivot member 30 may take any form that allows the housing to pivot relative to the support structure. In some configurations contemplated by the invention herein, the form of the housing assembly 14 and/or the support structure 32 may allow the housing and the support structure to be directly connected in such a way that allows the housing assembly 14 to articulate relative to the support structure 32. In such cases what is described herein as a pivot member 30 may, but is not required, to be integrally formed as part of the housing assembly 14 and/or the support structure 32.

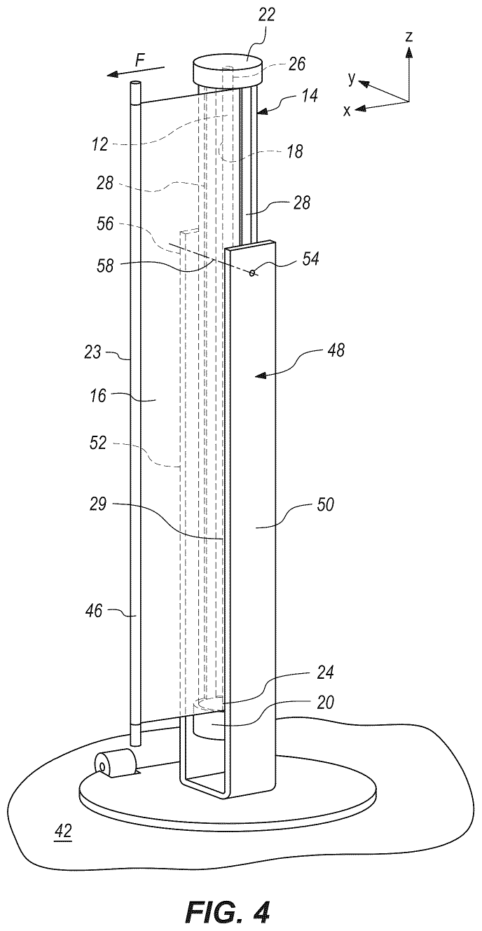

Turning now to FIG. 4 of the drawings, there is provided an alternative embodiment of the improved retractable banner assembly of the present invention. In this alternative embodiment, housing assembly 14 is coupled to a u-shaped support structure 48 resembling a tuning fork having corresponding prongs or tines 50 and 52 and pivot points 54 and 56, respectively. The foregoing coupling of frame 14 at pivot points 54 and 56 enables housing assembly 14 (along with and spool 12 and banner 16) to articulate relative to support structure 48 and walking surface 42 about pitch axis (y-axis) 58 formed thereby, responsive to a direction of the applied pull force F. In the embodiment shown, pitch axis 58 is again oriented substantially horizontally and thus substantially perpendicular to tines 50 and 52 and substantially parallel to walking surface 42, again it being understood that any suitable orientation of axis 58 may be acceptable depending on the desired application and structure of the support structure 46 and pivot points 54 and 57. Again, in keeping with the invention, the aforementioned articulation of housing assembly 14 relative to the support structure 48 and walking surface 42, responsive to a direction of the applied pull force F, enables equalization of force F across a cross-section 46 of rollable banner 16 thereby promoting rollable banner 16 to remain substantially flat on extension and retraction and when in a deployed state.

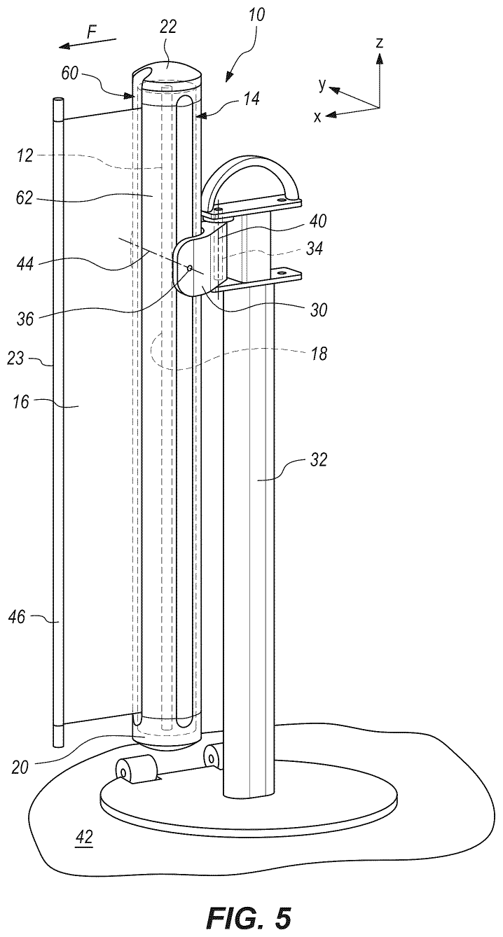

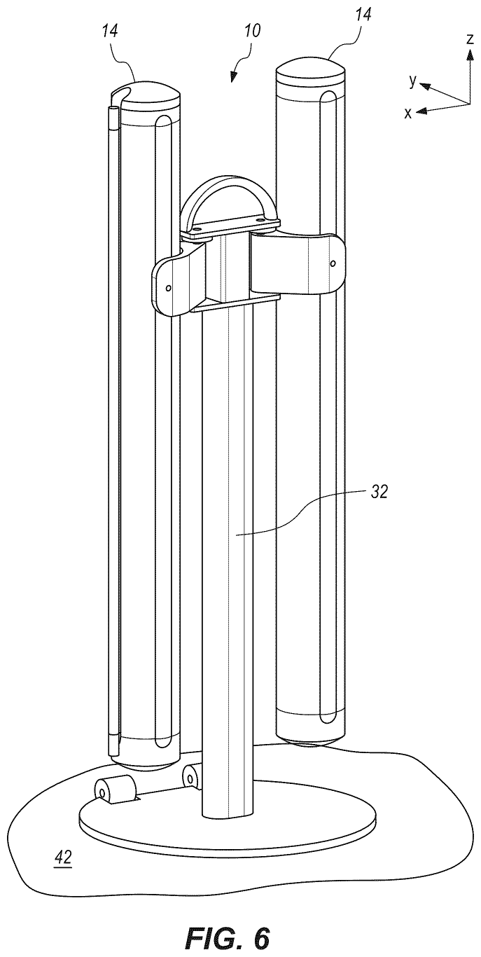

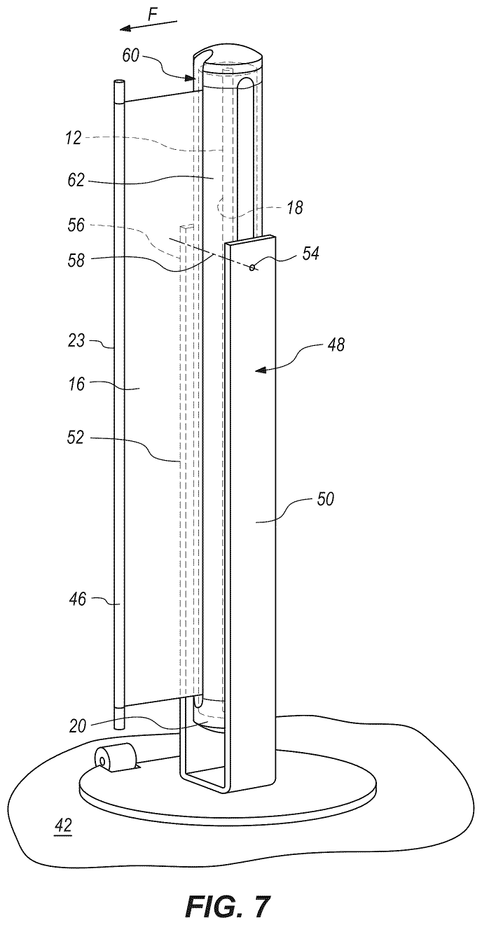

FIG. 5 of the drawings illustrates an alternative embodiment of the present invention wherein housing assembly 14 substantially encloses spool 12 and rollable banner 16. In this alternative embodiment, an elongated opening or slot 60 is provided in housing assembly 14 through which rollable banner 16 may extend through for deployment and retract back through for storage. In keeping with the invention, housing assembly 14 may again comprise any suitable material including plastic, metal, and the like, including any hybrid thereof. The outer surface may be smooth as shown or textured in whole or in part, including any etching or deposition of material including coating and/or laminating with any suitable material as desired for protection, ornamentation, and/or to enhance its performance or useable life. FIGS. 6-7 further illustrate alternative embodiments of the improved retractable banner assembly of the present invention incorporating the specific alternative embodiment of housing assembly 14 of FIG. 5.

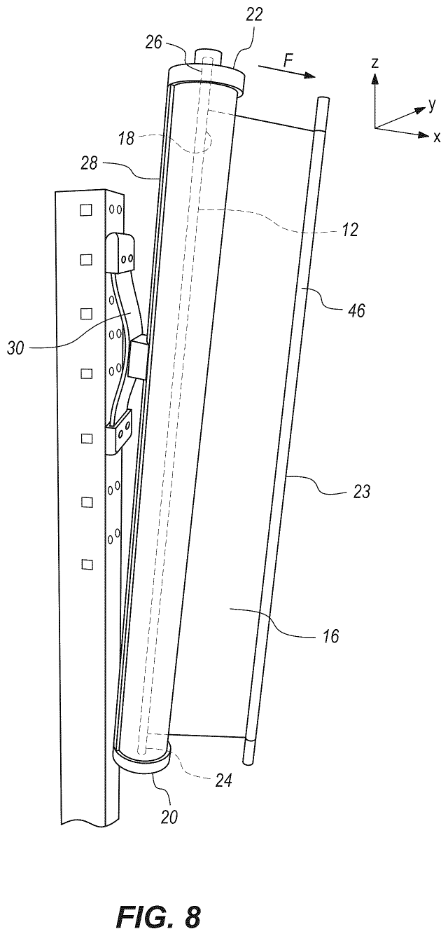

Turning now to FIG. 8 of the drawings, there is shown yet a further alternative embodiment of the improved retractable banner assembly 10 of the present invention. In this embodiment, housing assembly 14 and spool 12 may both rotate together and articulate together, in each case, about multiple axes. Like the embodiments of FIGS. 1-8, assembly 10 includes a spool 12, that is rotatably coupled directly or indirectly with housing assembly 14. A rollable banner 16 is further coupled at a trailing edge 18 thereof directly or indirectly to spool 12 for winding thereon. housing assembly 14, and specifically retaining members 20 and 22 thereof, retain corresponding proximal and distal ends 24 and 26 of spool 12 allowing spool 12 to rotate therein while restricting, and preferably prohibiting, all further movement of spool 12. Retaining members 20 and 22 accordingly allow spool 12 to rotate in a first direction responsive to an applied pulling force F on a leading edge 23 of rollable banner 16, and to rotate in a second and reverse direction upon reduction or release of the applied pulling force F. As shown, housing assembly 14 again minimally comprises retaining members 20 and 22 and at least one support arm 23 extending therebetween for further direct or indirect coupling to a pivot member 30 as described in further detail below. As indicated above, retaining members 20 and 22 could also be incorporated as an integral part of housing assembly 14. Housing assembly 14 may also enclose spool 12 in whole or in part, depending on the application, as also described below.

In this embodiment, banner assembly 10 may similarly include a winding mechanism such has a hand crank or the like (not shown) and/or any suitable biasing means including a spring, or similar mechanical or electromechanical mechanism (not shown) operative to apply a biasing force on spool 12 and thus rollable banner 16. In such case, a threshold pull force will be required to unroll and thus extend banner 16 from spool 12 for use and deployment. Such biasing means may further cause banner 16 to roll and thus retract upon release in whole or part of the threshold or applied pull force F, and preferably, but not necessarily, return to a fully rolled storage position. In keeping with the invention, a pivot member designated generally by reference numeral 30 comprises an elastomeric band or bracket that directly or indirectly couples housing assembly 14 to any suitable internal or external support structure 32 such as again by way of example only and not limitation, a stanchion, a support member of a pallet rack assembly as shown, a retail check-out aisle, and the like. As those skilled in the art will recognize, elastomeric brackets are typically made from rubber-like materials, known as elastomers. These elastomers have unique mechanical properties typically including low deformation modulus, which allows them to absorb loads and deform without permanent damage, and high durability to comply temporarily with the direction of the applied pull force to allow the pivoting and rotation of assembly 10 and then the return to a neutral position after removal of the applied pull force.

In keeping with the invention, support structure 32 may again be fixed, mountable, portable, self-supporting, anchorless, stanchion based, or incorporate any other suitable form and structure. In the exemplary, but not required embodiment shown in FIG. 8, pivot member 30 is coupled directly or indirectly to support structure 32 by mounting fasteners (not shown) and is further coupled directly or indirectly to housing assembly 14 in a similar fashion. The elastomeric material and structure of pivot member 30 provides flexibility and resilience enabling housing assembly 14 (along with spool 12 and rollable banner 16), to rotate about multiple common axes 62, 33, and 31, providing a range of roll, pitch, and yaw as shown by arrows 37, 33, and 31, respectively, in each case responsive to a direction of the applied pull force F, again which force and/or direction may be variable. In keeping with the invention, roll, pitch, and yaw axes may be oriented as x, y, and z axes respectively, having an origin point of (0, 0, 0) and a directional endpoint of (x, y, z). In further keeping with the invention, the aforementioned rotational properties generally, and articulation of housing assembly 14 relative to the support structure 32 and walking surface 42, responsive to a direction of the applied pull force F, specifically, enables equalization of at least part of force F across at least a cross-section 46 of rollable banner 16 thereby promoting rollable banner 16 to remain substantially flat on extension and retraction and when in a deployed state, including when the applied pull force and/or the direction thereof are variable.

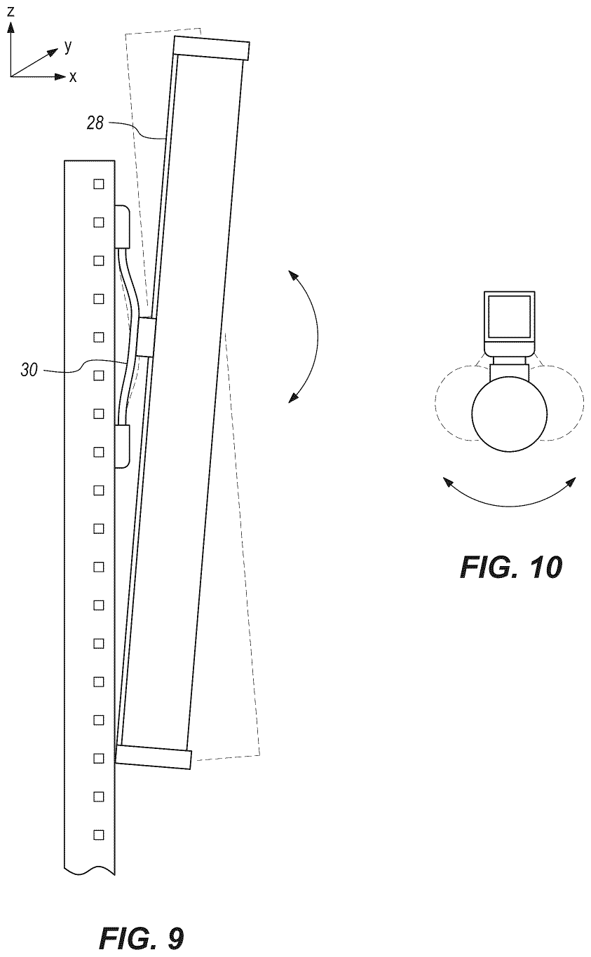

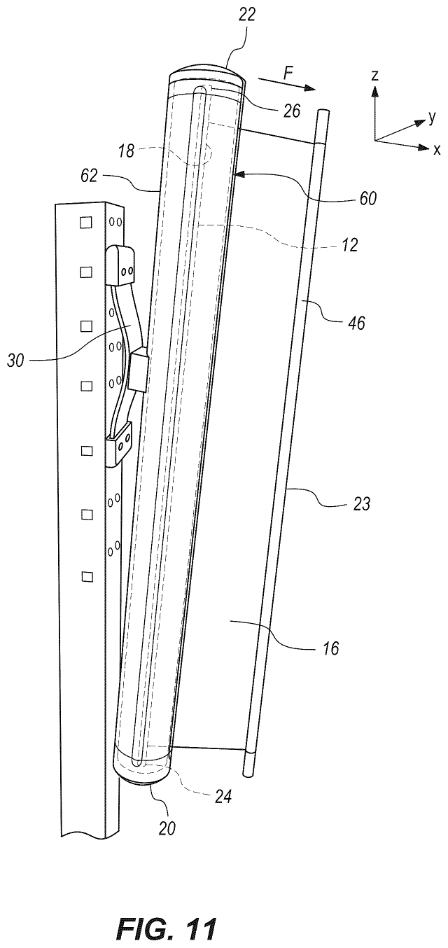

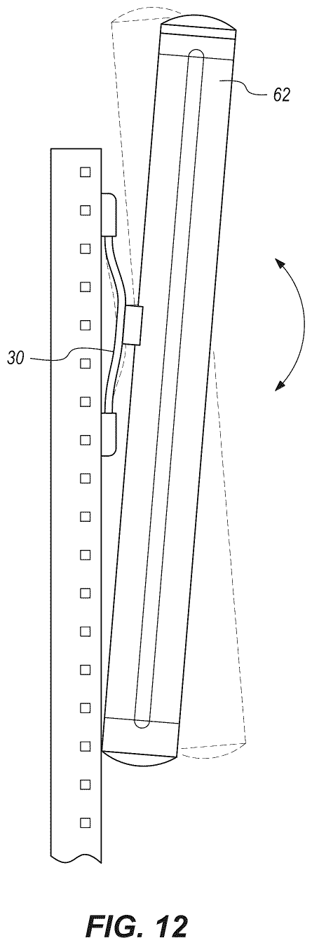

FIGS. 9-10 provide further detail of the roll, pitch, and yaw capabilities of frame assembly 14 (and concurrent roll, pitch, and yaw capabilities of assembly 14, spool 12 and banner 16) according to the alternative embodiment of the present invention described above wherein common yaw axis 40 is oriented substantially vertically as a z axis and is accordingly substantially parallel to support structure 32 and substantially perpendicular to walking surface 42, pitch axis 44 is oriented substantially horizontally as a y axis and is accordingly substantially perpendicular to support structure 32 and substantially parallel to walking surface 42, and roll axis 62 is oriented substantially horizontally as a x axis and is accordingly substantially perpendicular to support structure 32 and substantially parallel to walking surface 42. Again, it is understood that any suitable orientation of axes 40, 44, and 62 may be acceptable depending on the desired application of the retractable banner assembly 10 and the corresponding structure of pivot member 30. Referring to FIG. 9, for example, arrow 33 illustrates articulation of housing assembly 14 (and concurrent articulation of housing assembly 14, spool 12, and rollable banner 16) about pivot member 30 and pitch axis 40 defined thereby relative to the support structure 32 and a walking surface 42 responsive to a direction of the applied pulling force F. Arrow 37 of FIG. 9 similarly illustrates rotation of frame assembly 14 (and concurrent rotation of frame assembly 14, spool 12, and rollable banner 16) about pivot member 30 and roll axis 62 defined thereby relative to the support structure 32 and a walking surface 42 responsive to a direction of the applied pull force F. Arrow 31 of FIG. 10 similarly illustrates rotation of frame assembly 14 (and concurrent rotation of frame assembly 14, spool 12, and rollable banner 16) about pivot member 30 and yaw axis 44. FIGS. 11-12 illustrate the above referenced embodiment modified to incorporate the housing assembly of FIG. 5.

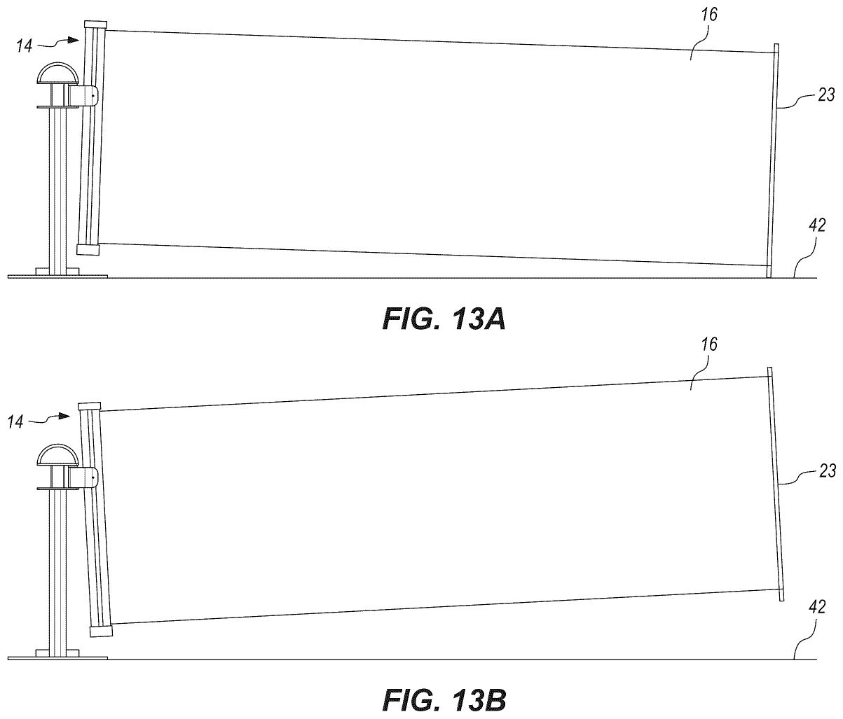

Turning now to FIGS. 13A-13B, housing assembly 14 is shown articulating generally, and concurrently with spool 12 and banner 16 specifically, providing a range of pitch about the y reference axis, to accommodate off-center applied pull force F applied to leading edge 23 of rollable banner 16. As those skilled in the art will recognize, such off-center pull forces F, which may be variable, are contemplated to be applied for a variety of reasons including, but not limited to, user operation, as well as the positioning of the leading edge of the banner when in a deployed state relative to its trailing edge, which may result in whole or in part in many cases due simply to an uneven walking surface across the length of the banner 16 arising from different floor materials, structural settling, ground shifting, improper workmanship, and the like. FIG. 13A shows this ground surface 42 higher at the trailing edge of rollable banner 16 and FIG. 13B shows the ground surface 42 higher at the leading edge, respectively. In each case, off-center pull force F is applied to accommodate the uneven surface and articulate banner 16 accordingly such that, in keeping with the invention, applied pull force F remains substantially normal to the axis of rotation of spool 16, namely the z reference axis. In the example shown, retractable banner assembly 10 is shown coupled to another support structure 32 which may, but is not required to be, a support arm of a similar retractable banner assembly. The range of pitch of the foregoing provided by the present invention enables the applied pull force F to equalize at least in part across at least a cross-section 46 of banner 16 thereby promoting rollable banner 16 to remain substantially flat upon extension and retraction and when in a deployed state.

It is understood that many alternative embodiments of an improved retractable banner assembly may be constructed in accordance with the present invention comprising different structures, materials, couplings, ball joints, universal joints, swivel joints, gimbal joints, linear bearing systems, curved bearing systems, hinges, and the like, of which the foregoing are just exemplary, wherein a housing assembly articulates by or through any suitable means about at least one y reference axis or pitch axis, and may further rotate about at least one z reference axis or yaw axis and/or at least one x reference axis or roll axis, in each case responsive to an applied pull force, respectively, on the banner generally, and responsive to a direction of such applied pull force specifically. The foregoing alone and in combination, equalizing at least part of such forces across at least a cross section of the banner, typically but not necessarily in the y-z plane, on extension and retraction and when in a deployed state to promote the banner to remain substantially flat. By way of further example, and not limitation, a first housing assembly may accordingly enclose all or part of a mounting rod that is rotatably coupled directly or indirectly thereto. A rollable fabric such as a banner may further be coupled directly or indirectly to the mounting rod and be extensible therefrom for deployment and retractable thereto, responsive to an applied pull force. The first housing assembly may further be disposed within or proximate to one or more secondary housing assemblies or other structures that similarly enclose all or part of the first housing assembly and are coupled thereto directly or indirectly, in any suitable manner, such as by way of example, and not limitation, any suitable coupling assembly or coupling member. In keeping with the invention, the coupling of the pivot member to the first housing assembly and the secondary housing assembly, enables the first housing assembly (along with the mounting rod rotatably coupled thereto and the banner) to articulate about a y or pitch axis within and relative to the secondary housing assembly on extension and retraction, and when in a deployed state, and more specifically, to articulate about the y axis responsive to a direction of the applied pull force on the banner. The coupling may, but is not required to, further enable the first housing assembly (along with the mounting rod, the secondary housing assembly, and the banner) to rotate together about a common z or yaw axis relative to a support assembly. Still further, the coupling may, but is not required to, enable the first housing assembly (along with the mounting rod, the secondary housing assembly, and the rollable banner) to rotate together about a common x or roll axis relative to a support assembly. Depending on how and where the first housing assembly is coupled to the secondary housing assembly, at least one end of the first housing assembly, which may be referred to for convenience as a distal end, and preferably, but not necessarily, as second end, further referred to for convenience as a proximal end, may articulate together with the corresponding distal and proximal ends of the mounting rod, again relative to the secondary housing assembly.

Accordingly, while exemplary embodiments of the invention have been illustrated and described, it is not intended that these embodiments illustrate and describe all possible forms of the invention, and such embodiments are not intended to limit the scope or the application or claims in any way. Rather, the words used in the specification are words of description rather than limitation, and it is understood that various changes may be made, and equivalent structures, features, and functions may be provided, without departing from the spirit and scope of the invention and defined by the following claims.

1. A retractable banner assembly, comprising:
a housing assembly for coupling directly or indirectly with a support structure;
an elongate mounting rod rotatably coupled directly or indirectly with the housing assembly;
a rollable banner coupled directly or indirectly with the mounting rod, the banner extensible therefrom for deployment and retractable thereto, responsive to an applied pull force;
wherein the housing assembly articulates relative to the support structure.

2. The retractable banner assembly of claim 1, wherein the housing assembly articulates responsive to a direction of the applied pull force.

3. The retractable banner assembly of claim 1, wherein the housing assembly articulates thereby enabling at least partial equalization of the applied pull force across at least a cross section of the banner, promoting the banner to remain substantially flat when the banner is extended, retracted, or in a deployed state.

4. The retractable banner assembly of claim 1, wherein the elongate mounting rod and the housing assembly articulate substantially concurrently relative to the support structure.

5. The retractable banner assembly of claim 1, wherein the assembly is for selective placement by a user on or proximate to a walking surface and the housing assembly articulates about an axis that may be oriented substantially parallel to the walking surface.

6. The retractable banner assembly of claim 1, wherein the housing assembly articulates about an axis oriented as a y axis of an x-y-z reference system, providing the housing assembly a range of pitch relative to the y axis.

7. The retractable banner assembly of claim 3, wherein the housing assembly articulates about an axis oriented as a y axis of an x-y-z reference system, and the cross section is in the y-z plane thereof.

8. The retractable banner assembly of claim 1, wherein the housing assembly encloses at least part of the elongate mounting rod.

9. The retractable banner assembly of claim 1, wherein the housing substantially encloses the elongate mounting rod and includes an elongate opening through which the rollable banner may extend and retract.

10. A retractable banner assembly, comprising:
a housing assembly;
an elongate mounting rod rotatably coupled directly or indirectly with the housing assembly;
a rollable banner coupled directly or indirectly to the mounting rod, the banner extensible therefrom for deployment and retractable thereto, responsive to an applied pull force; and
a pivot assembly directly or indirectly coupling the housing assembly to a support structure, the pivot assembly enabling the housing assembly to articulate relative to the support structure.

11. The retractable banner assembly of claim 10, wherein the pivot assembly is integral with the housing assembly, or the support structure, or the housing assembly and the support structure.

12. The retractable banner assembly of claim 10, wherein the housing assembly articulates responsive to a direction of the applied pull force.

13. The retractable banner assembly of claim 10, wherein the housing assembly articulates thereby enabling at least partial equalization of the applied pull force across at least a cross section of the banner, promoting the banner to remain substantially flat when the banner is extended, retracted, or in a deployed state.

14. The retractable banner assembly of claim 10, wherein the elongate mounting rod and the housing assembly articulate substantially concurrently relative to the support structure.

15. The retractable banner assembly of claim 10, wherein the assembly is for selective placement by a user on or proximate to a walking surface and the housing assembly articulates about an axis that may be oriented substantially parallel to the walking surface.

16. The retractable banner assembly of claim 10, wherein the housing assembly articulates about an axis oriented as a y axis of an x-y-z reference system, providing the housing assembly a range of pitch relative to the y axis.

17. The retractable banner assembly of claim 13, wherein the housing assembly articulates about an axis oriented as a y axis of an x-y-z reference system, and the cross section is in the y-z plane thereof.

18. The retractable banner assembly of claim 10, wherein the housing assembly encloses at least part of the elongate mounting rod.

19. The retractable banner assembly of claim 10, wherein the housing substantially encloses the elongate mounting rod and includes an elongate opening through which the rollable banner may extend and retract.

20. A retractable banner assembly, comprising:
a housing assembly;
an elongate mounting rod rotatably coupled directly or indirectly with the housing assembly;
a rollable banner coupled directly or indirectly to the mounting rod, the banner extensible therefrom for deployment and retractable thereto, responsive to an applied pull force; and
a pivot member directly or indirectly coupling the housing assembly to a support structure, the pivot member enabling the housing assembly to articulate relative to the support structure.

21. The retractable banner assembly of claim 20, wherein the pivot member is integral with the housing assembly, or the support structure, or the housing assembly and the support structure.

22. The retractable banner assembly of claim 20, wherein the housing assembly articulates responsive to a direction of the applied pull force.

23. The retractable banner assembly of claim 20, wherein the housing assembly articulates thereby enabling at least partial equalization of the applied pull force across at least a cross section of the banner, promoting the banner to remain substantially flat when the banner is extended, retracted, or in a deployed state.

24. The retractable banner assembly of claim 20, wherein the elongate mounting rod and the housing assembly articulate substantially concurrently relative to the support structure.

25. The retractable banner assembly of claim 20, wherein the assembly is for selective placement by a user on or proximate to a walking surface and the housing assembly articulates about an axis that may be oriented substantially parallel to the walking surface.

26. The retractable banner assembly of claim 20, wherein the housing assembly articulates about an axis oriented as a y axis of an x-y-z reference system, providing the housing assembly a range of pitch relative to the y axis.

27. The retractable banner assembly of claim 23, wherein the housing assembly articulates about an axis oriented as a y axis of an x-y-z reference system, and the cross section is in the y-z plane thereof.

28. The retractable banner assembly of claim 20, wherein the housing assembly encloses at least part of the elongate mounting rod.

29. The retractable banner assembly of claim 20, wherein the housing substantially encloses the elongate mounting rod and includes an elongate opening through which the rollable banner may extend and retract.

30. A retractable banner assembly, comprising:
a housing assembly for coupling directly or indirectly with a support structure;
an elongate mounting rod rotatably coupled directly or indirectly with the housing assembly;
a rollable banner coupled directly or indirectly with the mounting rod, the banner extensible therefrom for deployment and retractable thereto, responsive to an applied pull force;
wherein the housing assembly at least partially encloses the mounting rod and articulates responsive to a direction of the applied pull force, promoting the banner to remain substantially flat when the banner is extended, retracted, or in a deployed state.
